(19) United States
(12) Patent Application Publication
(10) Pub. No.: US 2015/0053336 A1
(43) Pub. Date: Feb. 26, 2015

(54) PROCESS MODULE, FABRICATING METHOD THEREOF AND SUBSTRATE PROCESSING METHOD USING THE PROCESS MODULE

(71) Applicants: Yong Jin Lim, Anseong-si (KR); Jae Jeong Kwak, Seoul (KR)

(72) Inventors: Yong Jin Lim, Anseong-si (KR); Jae Jeong Kwak, Seoul (KR)

(21) Appl. No.: 14/346,366

(22) PCT Filed: Feb. 19, 2014
(86) PCT No.: PCT/KR2014/001327

§ 371 Date: Mar. 21, 2014

(30) Foreign Application Priority Data
Aug. 23, 2013 (KR) 10-2013-0100658

(51) Int. Cl. B32B 38/10; B32B 37/12

(52) U.S. Cl. CPC B32B 38/10; B32B 37/12; B32B 37/1284; B32B 2457/20
USPC 156/247; 156/538; 156/60

(57) ABSTRACT

Disclosed are a process module, a fabrication method thereof, and a substrate processing method using the process module. The process module includes a structure in which cell substrates are fixed on a carrier member by an adhesive according to a preset alignment standard. The fabrication method includes aligning the cell substrates according to a preset alignment standard, applying an adhesive to at least one of surfaces facing each other between the cell substrates and the carrier member, and attaching the cell substrates to the carrier member by using the adhesive. The substrate processing method includes performing the substrate processing process of the cell substrates at the same time by using the process module integrated with the cell substrates. The substrate processing method selectively includes calibrating the alignment standard for the cell substrates in the substrate processing process to an alignment state of the cell substrates in the process module.

### TECHNICAL FIELD

The present invention relates to a process module, a fabricating method thereof, and a processing method of a substrate using the process module.

The term “substrate” used herein relates to a surface element used in a display device.

Also, the term “processing” includes a process for providing a decorative element, such as a surface pattern, and a process for providing a functional element, such as a thin film, on a substrate.

### BACKGROUND ART

For substrates recently used in display devices, surface-strengthened glass is adopted for a cover glass or a touch screen glass constituting the outer surface of the display device for protection from abrasion and impact. In particular, in the case of substrates used in display devices with high portability and minimized bezel width, for example, smartphones, since the sides of substrate are vulnerable to external impact, mechanical or chemical polishing is performed to reduce micro cracks and thus improve the strength, or strengthening is performed to reinforce the strength of the surfaces of substrate, or all of polishing and strengthening are performed. Furthermore, super high strength material, such as sapphire as well as typical surface-strengthened glass is employed.

With respect to these substrates, substrate processing process is performed to print a decorative element, such as a surface pattern or form a thin film, such as a sensor layer, an electrode layer, or the like for implementing a touch screen function. These existing substrate processing processes are performed by a “sheet method” or a “cell method”.

The “sheet method” is performed by strengthening a large sized bare sheet, selectively performing a printing or a thin film forming process only with respect to cell regions partitioned on the sheet, and then cutting and separating the bare sheet into the unit of cells. In such a “sheet method”, since the substrate processing process, such as printing or thin film forming, are performed in the unit of sheet, the “sheet method” has advantages, such as high productivity and low production costs.

However, in “the sheet method”, it is difficult to cut the surface-strengthened bare sheet into the unit of cells, and the strength of a cut surface, i.e., a side of the cell substrate is lowered due to micro cracks generated in cutting, so that product durability is reduced and yield is lowered due to the difficulty of mechanical machining.

As examples for solving the problems in the “sheet method”, Korean Patent Application No. 10-2012-7007863 discloses a method of cutting a chemically strengthened glass sheet by using a pulse laser, and Korean Patent Application No. 10-2012-0014156 discloses a method in which micro cracks generated in a physical cutting are reduced through a chemical etching or a cut surface is polished. The cutting and polishing disclosed in the related arts make up for the strength of the side to a certain extent in case the side is machined in the form of a straight line. But, since the cutting and polishing are performed basically with respect to the surface-strengthened bare sheet, it is difficult to machine a curved side or holes inside, so that an appearance design is limited. And, although strengthening is performed as a post process, it is difficult to secure sufficient strength, thus causing durability problem, so that the cutting and polishing have a difficulty in application of mass production.

In spite of efforts for solving problems caused in the cutting in such a “sheet method”, since the “sheet method” may not give the sufficient strength to the side of substrate cut and exposed, the “sheet method” is limitedly applied only to the fabrication of substrates used in tablet PCs or display devices for notebook computers in which sufficient displaying area may be secured by covering the wide width of bezel with another structural element such as a case or a frame to augment the strength of the side. Consequently, the “sheet method” has an inherent limitation in that it may be limitedly applied only to the fabrication of substrates requiring a low lateral strength among substrates used in display devices with a minimized bezel width.

Furthermore, in the “cell method”, the durability of the substrate is obtained through chemical strengthening by exchanging of Na+ and K+ ions at a temperature of 500° C. or higher prior to the substrate processing process. But in case the chemical strengthening is adopted in the “sheet method”, since a printed layer or a thin film layer formed previously may be damaged by a high temperature chemical material, strengthening of the side of the cell substrate in the “sheet method” is practically impossible.

Meanwhile, Korean Patent Application No. 10-2013-0011942 which has been filed by the applicant of the present invention, discloses supplementing the strength of a cut side while maintaining the advantages of the “sheet method” by cutting only a portion of a sheet thickness in advance, performing chemical strengthening, performing a substrate processing process in the unit of sheets, and then finally cutting a remaining uncut portion of the sheet.

However, since, in the method disclosed in Korean Patent Application No. 10-2013-0011942, the size of the thickness partly cut should be a maximum in order to secure the lateral strength of a cut surface, this Korean Patent Application No. 10-2013-0011942 has a possibility that an uncut portion is inadvertently damaged during the substrate processing process in the unit of sheets.

As mentioned above, since the existing “sheet method” not only has advantages such as simplicity of process and high productivity, but also has inherent limitations in that the supplementation of the strength of a cut surface is not sufficient and strengthening is difficult, the “cell method” in which cell substrates is previously separated from a bare sheet to be polished and strengthened before a substrate processing process, is generally adopted as a practical solution for fabricating a substrate applicable to a display device, such as a smartphone with high portability and a minimized bezel width.

Since the strengthening is performed in the state that the bare sheet is cut in the unit of cell substrates in the “cell method”, the “cell method” has advantages capable of effectively solving the above described limitations of the “sheet method”, i.e., processing quality and the lateral strength. However, the “cell method” has also the problem such as lower productivity and price competitiveness than the “sheet method”, because the substrate processing process is performed in the state that each of the cell substrates is received in each of individual jigs in the “cell method”.

Further, the “cell method” has a practical problem in that the cutting process is performed prior to the substrate processing process. That is, the current cutting technique has a tolerance in a range of ±30 μm due to technical limitations. Such a tolerance causes a gap of a few ten micrometers or more between a side of the cell substrate and an inner wall of the jig, and the gap is a relatively large value in the substrate processing process, such as forming a printed layer or a thin film layer of which process is planned to be performed at the accuracy of a few micrometers.

Resultantly, in the existing “cell method”, separate operations for precisely aligning the cell substrate received in the jig and fixing the cell substrates by using a vacuum chuck device provided below the jig in the aligned state should precede the scheduled substrate processing process(es). In particular, such substrate alignment and temporary fixing should be repeatedly performed before each of plural substrate processing processes, and thereby the low productivity in the “cell method” get further deteriorated.

In addition, in case there is a restricted condition that the plurality of substrate processing processes should be performed separated temporally and spatially, each of the cell substrates in the existing “cell method” should be independently handled after each of the substrate processing processes is completed. As a result, not only the possibility each cell substrate itself may be directly exposed to an external environment to damage but also the incidental expense for preventing such a damage is increased at the same time.

As described above, in processing the window substrate used in a display device, such as the smartphone with high portability and a minimized bezel width, the existing “sheet method” has unsolved problems in that the processing quality of a cut surface and the lateral strength decrease, and the existing “cell method” has unsolved problems in that the productivity and the price competitiveness decrease. Therefore, a new substrate processing method capable of solving these various problems at the same time is needed.

### DISCLOSURE OF THE INVENTION

### Problem to Solve

An object of the present invention is to provide a new substrate processing method having high productivity while maintaining the processing quality and/or the lateral strength for a cut surface of a substrate used in a display device.

Another object of the present invention is to provide a new substrate processing method capable of maintaining high production efficiency while decreasing the possibility of damage of a substrate even in a circumstance that respective substrate processing processes are temporally or spatially separated.

Still another object of the present invention is to provide a new substrate processing method suitable for the fabrication of a substrate used in a display device, particularly, such as a smartphone with high portability and a minimized bezel width.

Yet another object of the present invention is to provide a process module used in the above substrate processing method and a fabrication method thereof.

### Technical Solution

In the course of developing a new substrate processing method by which a substrate suitable for the use in a display device having high portability and a minimized bezel width, such as a smartphone may be fabricated with high productivity and yield, the inventors have perceived necessity to improve inefficiency in the substrate processing process by the existing “cell method”, on the premise that the separation process of a bare substrate into cell substrates in the unit of cells and/or the strengthening process should be performed prior to the substrate processing process in order to secure the processing quality and the lateral strength for a side of the substrate as like the existing “cell method”.

In detail, the inventors have perceived that the inefficiency of the existing “cell method” has a major factor that in respective substrate processing processes, an operation of aligning individual cell substrates and an operation of temporarily fixing the aligned cell substrates are repeatedly performed in the unit of individual cell substrates. In order to solve the problem, the inventors have contrived the idea of fabricating a process module having a structure in which a plurality of cell substrates are integrally implemented on a separate carrier member in aligned state, and introducing the process module as a unit for the substrate processing process, and have adopted the idea as a basic technical concept of the present invention for improving the inefficiency in the substrate processing process by the “cell method”.

In the course of further embodying the above basic technical concept, in order to expect substantial efficiency in the substrate processing process, the inventors have perceived the following items as other major objects to be solved: (a) while the process module is fabricated, a plurality of process modules are the same in aligned state (hereinafter, referred to as a “module template”) of cell substrates as each other, and the “module template” is identically reproduced to an alignment standard (hereinafter, referred to as a “process template”) for a plurality of cell substrates required in the processing process, (b) the “module template” is maintained without any change before and after the substrate processing process, and (c) after the substrate processing process is completed, the cell substrates are easily separated from the process module.

Particularly, in relation to item (a), a solving means has been embodied in consideration of a tolerance for the cell substrates generated when a bare sheet is cut into cell substrates, and a tolerance generated when a tool, such as a jig used for fabricating the process module is machined, and in relation to items (b) and (c), a solving means has been embodied in consideration of process conditions in the respective substrate processing processes, easiness in the course of separating the cell substrates, and suppression of damage of the cell substrates and a carrier member after separation, thus resulting in the present invention. Meanwhile, if a plurality of substrate processing processes separated temporally and spatially each other are planned, the cell substrates may be separated from the process module after the final substrate processing process.

The subject matters of the present invention regarding the recognitions of the above-described objects to be solved and the solving means based on the recognitions are as follows.

(1) A substrate processing method in which at least one substrate processing process is performed with respect to a plurality of cell substrates separated from a bare sheet, the method including: fabricating a process module having a structure in which the plurality of cell substrates are attached to a carrier member in an aligned state; and performing the substrate processing process by using the fabricated process module.

(2) The method of item (1), wherein the cell substrate is surface-strengthened before the process module is fabricated.

(3) The method of item (1), wherein the attaching of the cell substrates to the carrier member uses a debondable adhesive.

(4) The method of item (3), wherein the debondable adhesive is a warm water-peelable adhesive or a UV peelable adhesive.

(5) The method of item (1), wherein the at least one substrate processing process provides at least one of a decorative element and a functional element.

(6) The method of item (1), wherein the substrate processing process includes at least two substrate processing processes which are separated temporally or spatially.

(7) The method of item (5), wherein the functional element includes a sensor layer or an electrode layer for a touch screen function.

(8) The method of item (1), wherein the substrate processing process is a process of attaching devices which are machined to a final dimension.

(9) The method of item (1), wherein the carrier member has the same thermal expansion coefficient as the cell substrates.

(10) The method of item (1), wherein the carrier member has a structure in which a plurality of first carrier members are attached to a second carrier member, and the plurality of cell substrates are attached to each of the plurality of first carrier members.

(11) The method of item (1), further including separating the cell substrates from the carrier member after the substrate processing process.

(12) The method of item (11), wherein the attaching of the cell substrates to the carrier member uses a debondable adhesive, and the separating of the cell substrates from the carrier member is performed by dipping the process module in water.

(13) The method of item (11), wherein the attaching of the cell substrates to the carrier member uses a debondable adhesive, and the separating of the cell substrates from the carrier member is performed by irradiating UV light.

(14) The method of item (11), further including cleaning the cell substrates separated from the carrier member.

(15) The method of item (1), wherein the fabricating of the process module includes: aligning the plurality of cell substrates according to a preset alignment standard; applying an adhesive to at least one of surfaces facing each other between the plurality of cell substrates and the carrier member; and attaching the plurality of cell substrates to the carrier member by using the adhesive.

(16) The method of item (15), wherein the aligning of the plurality of cell substrates uses an alignment jig on which an orthogonal grid for center alignment is marked, and is performed in a manner that a virtual orthogonal grid on the cell substrates is matched to the orthogonal grid for center alignment.

(17) The method of item (16), wherein a seat for receiving the plurality of cell substrates is provided to the center alignment jig, and the orthogonal grid for center alignment is matched to the center of the seat.

(18) The method of item (15), wherein the aligning of the plurality of cell substrates is performed by using an alignment jig having a seat for receiving the plurality of cell substrates, and the plurality of cell substrates are aligned to the center or the corner of the seat.

(19) A process module used in a substrate processing method performing at least one substrate processing process for a plurality of cell substrate separated from a bare sheet, wherein the plurality of cell substrates are attached to a carrier member by an adhesive according to a preset alignment standard.

(20) The process module of item (19), wherein the cell substrates is surface-strengthened.

(21) The process module of item (19), wherein the adhesive is a debondable adhesive.

(22) The process module of item (21), wherein the debondable adhesive is a warm water peelable adhesive or a UV peelable adhesive.

(23) The process module of item (19), wherein the carrier member has the same thermal expansion coefficient as the cell substrate.

(24) The process module of item (19), wherein the carrier member has a structure in which a plurality of first carrier members are attached to a second carrier member, and the plurality of cell substrates are attached to each of the plurality of first carrier members.

(25) The process module of item (19), wherein the carrier member is provided with a plurality of holes, and each of the cell substrates is attached to a bridge between the plurality of holes.

(26) The process module of item (19), wherein the carrier member is provided with a recess for receiving the cell substrates.

(27) The process module of item (19), wherein a filler filling the space between the cell substrates is provided on the upper surface of the carrier member.

(28) The process module of item (26), wherein an extraction groove is formed at the side of the recess of the carrier member.

(29) The process module of item (26), wherein a hole is formed at the bottom of the recess of the carrier member.

(30) The process module of item (19), wherein an alignment mark is provided to the carrier member.

(31) The process module of item (19), wherein the cell substrate includes a printed layer, a thin film layer, or the combination thereof.

(32) The process module of item (31), wherein the thin film layer includes a sensor layer or an electrode layer for a touch screen function.

(33) A method for fabricating a process module used in a substrate processing method performing at least one substrate processing process for a plurality of cell substrate separated from a bare sheet, the method including: aligning the plurality of cell substrates according to a preset alignment standard; applying an adhesive to at least one of surfaces facing each other between the plurality of cell substrates and the carrier member; and attaching the plurality of cell substrates to the carrier member by using the adhesive.

(34) The method of item (33), wherein the aligning of the plurality of cell substrates is performed by using an alignment jig on which an orthogonal grid for center alignment is marked, in a manner that a virtual orthogonal grid for the cell substrates is matched to the orthogonal grid for center alignment.

(35) The method of item (33), wherein a seat for receiving the plurality of cell substrates is provided to the alignment jig, and the center of the orthogonal grid for center alignment is matched to the center of the seat.

(36) The method of item (33), wherein the aligning of the plurality of cell substrates is performed by using an alignment jig having a seat for receiving the plurality of cell substrates, and the plurality of cell substrates are aligned to the center or the corner of the seat.

(37) The method of item (33), further including temporarily fixing the plurality of cell substrates by a vacuum suction.

(38) A substrate processing method performing at least one substrate processing process for a plurality of cell substrates separated from a bare sheet, the method including: fabricating a process module having a structure in which the plurality of cell substrates are attached to a carrier member in an aligned state; and performing the substrate processing process for the plurality of cell substrates at the same time by using the process module, wherein the alignment standard for the plurality of cell substrates in the substrate processing process is calibrated to the alignment state of the cell substrates in the process module.

(39) The method of item (38), wherein the cell substrate is surface-strengthened before the process module is fabricated.

(40) The method of item (38), wherein the attaching of the cell substrates to the carrier member is performed by using a debondable adhesive.

(41) The method of item (38), wherein the debondable adhesive is a warm water peelable adhesive or a UV peelable adhesive.

(42) The method of item (38), wherein the at least one substrate processing process provides at least one of a decorative element and a functional element.

(43) The method of item (38), wherein the substrate processing process includes a plurality of substrate processing processes, which are separated temporally or spatially.

(44) The method of item (42), wherein the functional element includes a sensor layer or an electrode layer for a touch screen function.

(45) The method of item (38), wherein the substrate processing process is a process of attaching devices to each other, which are machined to a final dimension.

(46) The method of item (38), wherein the carrier member has the same thermal expansion coefficient as the cell substrate.

(47) The method of item (38), wherein the carrier member has a structure in which a plurality of first carrier members are attached to a second carrier member, and the plurality of cell substrates are attached to each of the plurality of first carrier members.

(48) The method of item (38), further including separating the cell substrates from the carrier member after the substrate processing process is performed.

(49) The method of item (48), wherein the attaching of the cell substrates to the carrier member is performed by using a debondable adhesive and the separating of the cell substrate from the carrier member is performed by dipping the process module in water.

(50) The method of item (48), wherein the attaching of the cell substrates to the carrier member uses a debondable adhesive, and the separating of the cell substrate from the carrier member is performed by irradiating UV light.

(51) The method of item (48), further including cleaning the cell substrate separated from the carrier member.

(52) The method of item (38), wherein the fabricating of the process module includes: aligning the plurality of cell substrates according to a preset alignment standard; applying an adhesive to at least one of surfaces facing each other between the plurality of cell substrates and the carrier member; and attaching the plurality of cell substrates to the carrier member by using the adhesive.

(53) The method of item (52), wherein the aligning of the plurality of cell substrates is performed by using an alignment jig on which an orthogonal grid for center alignment is marked, in a manner that a virtual orthogonal grid on the cell substrate is matched to the orthogonal grid for center alignment.

(54) The method of item (53), wherein a seat for receiving the plurality of cell substrates is provided to the alignment jig, and the center of the orthogonal grid for center alignment is matched to the center of the seat.

(55) The method of item (52), wherein the aligning of the plurality of cell substrates is performed by using an alignment jig provided with a seat for receiving the plurality of cell substrates, and the plurality of cell substrates are aligned to the center or the corner of the seat.

### Advantageous Effects

The substrate processing method using a process module according to the present invention performs a plurality of substrate processing processes in the unit of process module to remove repeated alignment and temporary fixing of individual substrates that should be repeatedly performed in each of the substrate processing processes in the existing “cell method”, thereby capable of securing high productivity and price competitiveness and suppressing the possibility of damage of substrates to the maximum extend even under circumstance that the respective substrate processing processes are separated temporally and spatially.

Also, the substrate processing method using a process module according to the present invention may be particularly advantageously applied to fabrication of substrates used in display devices such as smartphones having high portability and a minimized bezel width. For example, in fabricating a cover glass integrating with touch screen, the lateral strength of the glass may be maintained equally as the existing “cell method”.

Furthermore, the substrate processing method using a process module according to the present invention may be particularly advantageously applied to the processing of cell substrates which is difficult to adjust the final dimension thereof through cutting and polishing after the substrate processing process as in the existing “sheet method”, for example, substrates formed of a high strength material such as a surface-strengthened glass or sapphire.

Moreover, the substrate processing method according to the present invention may be latently applied to a process of attaching devices in a final dimension to each other so as to increase the productivity of the corresponding process remarkably.

### BRIEF DESCRIPTION OF THE DRAWINGS

FIG. 1 is a schematic view showing a substrate processing method according to an embodiment of the present invention.

FIG. 2 is a schematic view illustrating preparing of a substrate according to an embodiment of the present invention.

FIGS. 3 and 4 are a top plan view and a cross-sectional view of a process module according to an embodiment of the present invention.

FIG. 5 is a cross-sectional view illustrating a process module according to another embodiment of the present invention.

FIGS. 6 and 7 are a top plan view and a cross-sectional view of a process module according to another embodiment of the present invention.

FIGS. 8 and 9 are a top plan view and a cross-sectional view of a process module according to another embodiment of the present invention.

FIG. 10 is a cross-sectional view of a process module according to a modified embodiment of FIGS. 8 and 9.

FIG. 11 is a cross-sectional view of a process module according to another modified embodiment of FIGS. 8 and 9.

FIG. 12 is a cross-sectional view of a process module according to a further another modified embodiment of FIGS. 8 and 9.

FIG. 13 is a top plan of a process module according to a yet another embodiment of the present invention.

FIG. 14 is a flow chart showing a process of fabricating a process module according to an embodiment of the present invention.

FIG. 15 is a schematic view illustrating a process of fabricating a process module according to an embodiment of the present invention.

FIG. 16 is a top plan view and a cross-sectional view of an alignment jig according to an embodiment of the present invention.

FIG. 17 is a exploded perspective view and a cross-sectional view of an alignment jig according to another embodiment of the present invention.

FIG. 18 is a schematic view illustrating a center alignment of a cell substrate according to an embodiment of the present invention.

FIG. 19 is a schematic view illustrating an corner alignment of a cell substrate according to exemplary embodiments of the present invention.

FIG. 20 is a mimetic view illustrating a substrate processing process according to exemplary embodiments of the present invention.

### MODE FOR CARRYING OUT THE INVENTION

Hereinafter, embodiments of the present invention will be described in detail with reference to the accompanying drawings. In drawings, the same elements or equivalents are referred to with the same or similar reference numerals.

When it is said that a part “includes” an element, it means that the part may further include other elements unless it is said that the part does not include other elements explicitly.

Also, when it is said that an element is “selectively” provided, equipped, or included, it means that the element is not an element essentially selected for solving an object of the present invention but may be arbitrarily selected with relation to the object to be solved.

### (Overall Substrate Processing Method)

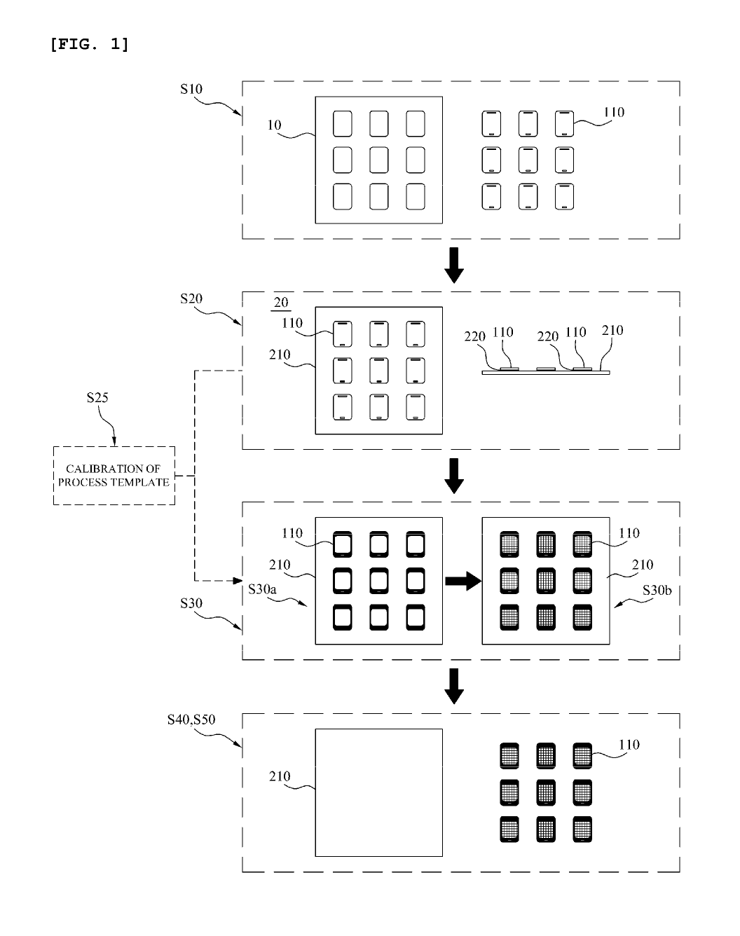

FIG. 1 is a schematic view illustrating a substrate processing method according to an embodiment of the present invention. The substrate processing method includes an operation (S10) of preparing a substrate including separating a plurality of cell substrates 110 from a bare sheet 10; an operation (S20) of fabricating a process module 20 having a structure in which the plurality of cell substrates 110 are attached on a carrier member 210; and an operation (S30) of performing processing processes of the plurality of cell substrates 110 at the same time by using the process module 20.

The “cell substrate” 110 is a surface element used in a display device, and in particular, in order to be used in a display device having a minimized bezel width, the cell substrate 110 includes a cover glass, a touch screen glass or a surface element similar to these, requiring characteristics, such as good processing quality, a predetermined strength or more, or both of these with respect to a side of the cell substrate.

The “processing” includes an operation (S30a) for providing a decorative element, such as a color, a logo, or a surface pattern to the cell substrate 110 or an operation (S30b) for providing a functional element, such as a sensor layer or an electrode layer thin film for a touch screen function. However, these processing operations (S30a and S30b) may be omitted, added or modified according to the uses of the cell substrates 110.

The processing for providing the decorative element may be an operation for forming a foreground color, a background color, color, an icon, a camera window, an infrared window, or a light bloking layer. The forming of the decorative element may be performed by printing a foreground color, a background color, a border, an icon, a camera window, an infrared window, a light blocking layer, and the like by using an ink in which an organic or nonorganic pigment, a solvent, a dispersing agent, a binder, and the like are mixed. In this case, the printing may be performed by using a printing device, such as an inkjet printer, a silk screen printer, or the like. Also, the forming of the decorative element may be performed by imprinting an organic pattern, performing a photo-etching after depositing a thin film or a colored photoresist (PR) for lithography.

The processing for providing the functional element may be an operation for forming a transparent conductive layer and a circuit layer, an index matching layer reducing a difference in refractive index, an interlayer insulating layer, a metal layer formed on an end portion of a transparent conductive layer. The forming of such a functional element may be performed in a way depositing a thin film through a sputtering or a chemical vapor deposition and then photo-etching the thin film to form a pattern. In this case, a heat treatment process may be included in order to improve conductivity of the conducting pattern. Also, the metal layer formed on the end portion of the transparent conductive layer may be formed by way of a printing, depositing, or photolithography.

Furthermore, this “processing” processes may include one or more processes which are continuous or be separated temporally or spatially. In this case, the “processing” processes being separated temporally or spatially means, for example, that processing processes A, B, and C are planned to be performed sequentially, after processing process A is performed, a subsequent processing process B or C which is isolated temporally or spatially from processing process A is performed without separating the cell substrate 110 from the process module.

The “process module” 20 is an aggregate of a plurality of cell substrates as a unit used in the “processing” process in order to improve inefficiency of an existing substrate processing method according to the “cell method”. The process module 20 is characterized by a structure in which the plurality of cell substrates 110 are ‘integrally’ attached′ on a separate carrier member 210 in an ‘aligned’ state.

The process module 20 includes not only a module in which the bare cell substrates 110 are attached on the carrier member 210, but also a module in the form of a half-finished product, i.e. in which one or more of “processing” processes are partially performed and provided for the following processing process(es) without a separating operation (S40) to be described later.

The “alignment” means that, when an alignment standard for the plurality of cell substrates 110 required in the substrate processing process is referred to as a “process template”, the plurality of cell substrates 110 are disposed on the carrier member 210 according to the “process template”. Here, the aligned state of the cell substrates 110 in the process module 20 as an end result is referred to as a “module template”. The “process template” is scheduled to be set in advance according to the substrate processing process(es) to be performed. This “process template” may be used as a standard coordinate for printing, fabricating of a screen plate, fabricating of a mask, exposing light, and the like in the substrate processing processes including, for example, printing, etching, and the like.

In terms of efficiency of the overall processing process, at least, the “module template” should be identically reproduced among the plurality of process modules 20. When the “module templates” of the plurality of process modules 20 are different from one another, since the “process template” in the “processing” process should be repeatedly calibrated or adjusted according to each “module template” of process modules 20, the efficiency of the entire process may be severely lowered.

In case of using an alignment jig as described later, the identity of the “module template” among the plurality of process modules 20 may be acquired by way of defining the center or the corner of a cell substrate as a reference point and aligning the reference point with the center or the corner of a seat provided to the alignment jig.

Further, it is preferable that the “module template” be identically reproduced among the plurality of process modules 20 and at the same time the “module template” be identically reproduced with the “process template”. Although the “module template” is different to the “process template”, it is possible to accomplish an object of the present invention, but in this case, there is required an additional operation (S25) of performing standardization or calibration for matching the “process template” in the “processing” process with the “module template”.

The identity between the “module template” and the “process template” may be acquired by way of aligning the center of the cell substrate 110 as a reference point as described later. In detail, the identity may be acquired by way of matching virtual orthogonal grids of the cell substrate 110 to physical orthogonal grids provided in a center alignment jig.

In other aspects of the efficiency of the overall substrate processing process, it is required that the “module template” of a process module 20 may be identically maintained before or after one or more substrate processing processes, and more preferably, the process module 20 may be easily separated into the cell substrate 110 and the carrier member 210 after the substrate processing process(es) is completed. In this regard, it is preferable that the plurality of cell substrates 110 basically have a structure in which the plurality of cell substrates 110 are integrally attached to the carrier member 210. And, it is also preferable that an adhesive 220 used to attach the plurality of cell substrates 110 and the carrier member 210 to each other is selected in consideration of process conditions required in the processing process, such as durability, alkali resistance, acid resistance, or heat resistance, easiness of adhesion and separation, and damage suppression of the cell substrate, etc.

The substrate processing method may further selectively include separating the process module 20 (S40) and cleaning the cell substrate 110 separated from the process module 20. As a result, the cell substrate 110 in which the substrate processing process(es) is completed is manufactured as a final product.

### (Preparing of Substrate)

Traditionally, display devices having a touch screen function, particularly, an electrostatic capacitive touch screen function have a structure in which a cover glass, a touch panel, and a display panel are laminated to be assembled. In such traditional ways, the touch panel is separately fabricated in the form of a film sensor or a glass sensor and is then disposed between the cover glass and the display panel. The film sensor includes types, such as GFF, GF2, GF1, etc., and the glass sensor includes types, such GG2 and GG, etc. Recently, it is applied a type such as G1, G2, and G1F, etc. in which a portion or all of the touch screen function implemented in the cover glass. There is an on-cell or in-cell in which the touch screen function is implemented in an integral type in the display panel, or an in/on-cell hybrid way in which an in-cell and an on-cell are combined.

Hereinafter, the operation of preparing a substrate will be described with the exemplary substrate to which the substrate processing process method according to the present invention may be especially advantageously applied. The exemplary substrate may be a cover glass or a touch screen glass of a display device having the above-described touch screen function.

However, as described above, since the cell substrate 110 of the present invention may basically include all of surface elements used in display devices, preparing of the cell substrate or a substrate processing process to be described later may be varied according to the uses of the cell substrate. Therefore, the preparing of the cell substrate or the substrate processing process to be described later is not construed as being limited by embodiments.

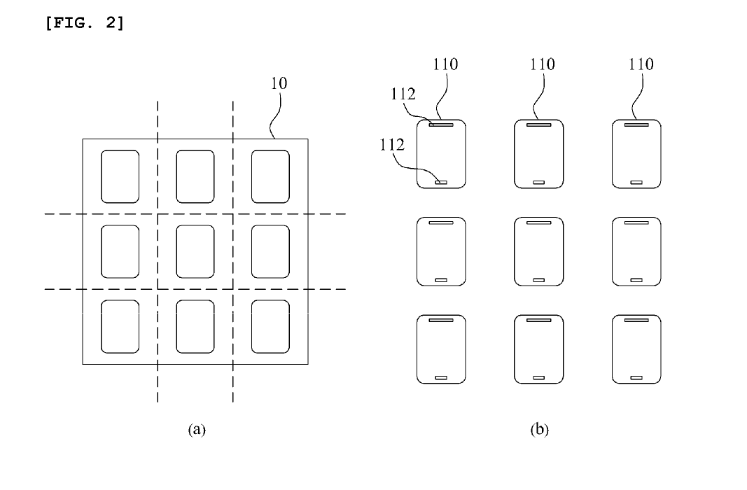

FIG. 2 illustrates preparing of a cell substrate when the cell substrate according to an exemplary embodiment of the present invention is used as a cover glass or a touch screen glass of a display device. In the exemplary embodiment, the cell substrate 110 is prepared through separation thereof from a bare sheer 10, a shape processing, polishing of a cut surface, strengthening of a surface, and inspection.

Firstly, the cell substrate 110 is cut from the bare sheet 10 by a physical method, such as a laser scribing and breaking, a water jet, a wire cutting, or a wheel cutting, etc., or a chemical method, such as a chemical etching, etc. Each of the cutting methods has a peculiar working tolerance, and it is, for example, known that the wire cutting with a small working tolerance is in a range of ±5 μm as the working accuracy thereof.

The bare sheet 10 may be an alumino-silica or boro-silica based glass with a high strength, or a soda-lime glass, or a sapphire, and is cut according to a size of a display device in which the cell substrate is being used.

The cell substrates 110 may be subject to a shaping process, such as a polishing or a glossing process of a surface or an side, or a process for drilling a hole in an inside of the cell substrates 110 by using a CNC machining or a chemical etching if necessary.

Surfaces including a side of the cell substrate 110 are strengthened by way of a thermal strengthening or a chemical strengthening, and when the thickness of the cell substrate 110 is thin, the chemical strengthening method is mainly used. The chemical strengthening may be performed in such a way that exchange of Na⁺ and K⁺ ions is induced in the surface of the cell substrate 110, for example, by making the cell substrate 110 formed of a glass material containing Na⁺ ions in contact with a salt bath containing K⁺ ions at a process temperature of about 500° C. In this case, since the radius (1.33 Å) of K⁺ ion is larger than that (0.98 Å) of Na⁺ ion, a compression stress is induced to a surface of the cell substrate 110 due to the exchange of Na⁺ ions and K⁺ ions, so that the strength is increased.

The cell substrates 110 in which the shape strengthening and the surface strengthening have been completed are classified into a good product and a bad product by inspecting suitability of the processing dimension and existence of surface defect prior to being introduced to the substrate processing process, and are fabricated in the form of a process module.

The inspecting is preferably performed by a non-contact three dimensional scanning method in consideration of a problem, such as a surface scratch that may be generated in handling of the cell substrates.

### (Structure of Process Module)

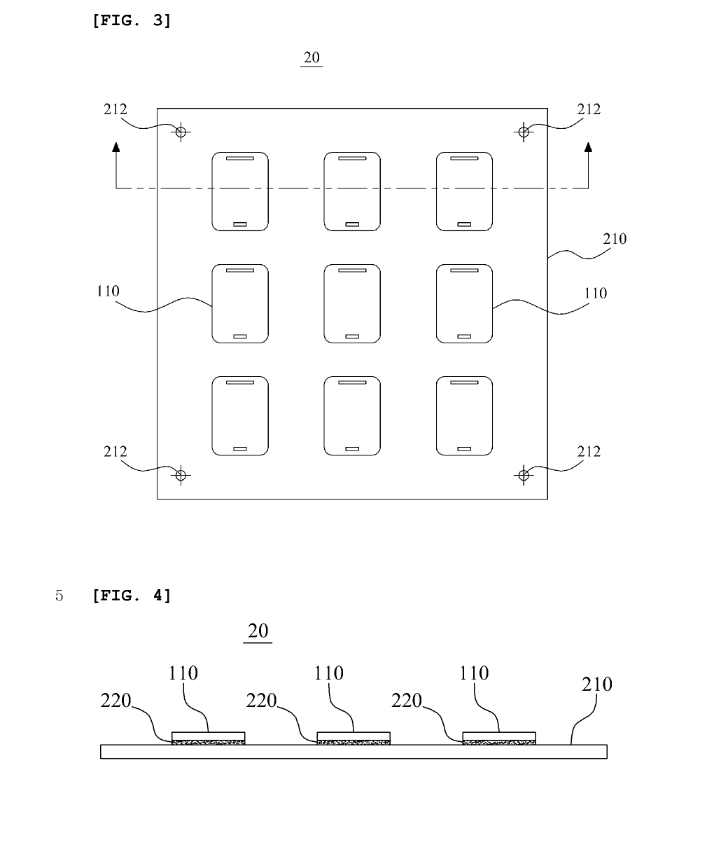

FIGS. 3 and 4 are a top plan view and a cross-sectional view illustrating a process module according to exemplary embodiments of the present invention. A process module 20 adopted as a unit of a substrate processing process in the present invention has a monolithic structure in which a plurality of cell substrates 110 are fixed in an aligned state to a separate carrier member 210 by an adhesive.

When used as cover glasses, touch screen glasses, or both in display devices as in the previous embodiments, the plurality of cell substrates 110 may be in a state that surfaces including sides are strengthened.

Also, the plurality of cell substrates 110 may be in a state that one or more of pre-arranged substrate processing processes has been performed. For example, in case the cell substrates 110 are used in cover classes of display devices and both of a decorative layer and a touch screen function layer are planned to be implemented on the cell substrates 110, the cell substrates 110 may be in a state that only a printing process for forming the decorative layer may have been performed (not shown).

Actually, this type of process module may be understood as follows; i.e. if a process module 20 mounting bare cell substrates 110 is not separated into cell substrates 100 after only a portion of the substrate processing processes is performed, and then the process module 20 may be recognized in the state of a half-finished product.

Even in a constrained state such that the substrate processing processes, such as printing, deposition, or photolithography and etching, etc. are separated temporally and spatially, the process module 20 in a half-finished product state is capable of maintaining the consistency of “module template” thereof and may be instantly introduced into a subsequent substrate processing process(es) after simply being aligned to the “process template” in the subsequent substrate processing process without any other operation, and thus, the efficiency of the overall substrate processing processes may be significantly improved.

The carrier member 210 is an element for mounting the plurality of cell substrates 110, and the material thereof is not particularly limited and may be properly selected from a glass, a metal, a plastic, or a composite material, and the like in consideration of reusability after the substrate processing process and process conditions required in the substrate processing process. Also, the carrier member 210 may be formed of several different material layers.

However, in case the substrate processing process is scheduled at high temperatures, the carrier member 210 is preferably selected from materials having the same thermal expansion coefficient as the cell substrate 110. This is to prevent the cell substrates 110 from being separated from the carrier member 210 or deformed and damaged inadvertently during the substrate processing process due to the thermal expansion coefficient difference between the cell substrate 110 and the carrier member 210.

Furthermore, the carrier member 210 includes an alignment mark 212 for matching the “module template” to the “process template” to align the process module 20, during the substrate processing process. The alignment mark 212 is not particularly limited and may be provided in a surface printing mark, such as a point, a line, a figure, or the like, or a shaping mark, such as a hole.

Since the adhesive 220 is scheduled to be peeled or removed from the process module 20 after the substrate processing process, it is preferable that a debondable adhesive capable of being separated or dissolved as necessary. The debondable adhesive may be provided in the form of a liquid phase or a double-sided tape.

The debondable adhesive may include a releasable adhesive, a hot-melt adhesive, a reworkable adhesive, a recyclable adhesive, and the like. The debondable adhesive is decomposed by a physical phenomenon, such as a cohesive failure or a peeling of an adhesive interface, such a physical phenomenon includes softening, melting, expansion, embrittlement, and the like. In case of a thermoplastic adhesive, softness, melting, bead expansion and embrittlement are major de-bonding factors and in case of a thermosetting adhesive, bead expansion and a thermal property control are typical de-bonding factors. A method for de-bonding trigger to activate such de-bonding factors may include heating, dipping, UV irradiation, and the like.

A debondable adhesive applied to the present invention may basically have easiness of adhesion and peeling and satisfy process conditions, such as durability, an alkali resistance, an acid resistance, a heat resistance, and the like required in the substrate processing process. In such terms, adhesives including an acrylic-based, an epoxy-based or a polyimide-based polymer resin as a major component may be advantageously applied, and the adhesive may include, for example, beads such as, micro capsules in order to make uniform the thickness of the adhesive. Also, a warm water peelable adhesive which is delaminated by dipping in a warm water of 80° C. to 90° C. or a UV peelable adhesive which is delaminated by irradiation of UV may be advantageously applied to the method for the de-bonding trigger.

Also, in case the adhesive 220 includes beads that are uniformly dispersed, the beads function as spacers between the cell substrate 110 and the carrier member 210 to make uniform the layer thickness of the adhesive 220, thereby improving accuracy of the substrate processing process.

Furthermore, it is preferable that the adhesive 220 has a lower adhesive force to the cell substrate 110 than that to the carrier member 210. This is, in the operation (S40 in FIG. 1) of separating the cell substrate 110 from the process module after the substrate processing process, to minimize possibility of a damage and to reduce the amount the adhesive 220 remaining on the cell substrate 110, thereby facilitating the operation (S50 in FIG. 1) of cleaning the cell substrate 110.

Moreover, if an original “module template” is not changed due to the degeneration of the adhesive in the substrate processing process, the adhesive 220 may be formed only on a portion of the cell substrate 110.

Meanwhile, the present invention preferably assumes that the “module template” which is an alignment state of the cell substrates 110 in the process module 20 is identical to the “process template” which is an alignment standard for the plurality of cell substrates 200 required in the substrate processing process. Nevertheless, as described later, the present invention also includes a case where the “module template” is different from the “process template” due to an alignment method of the cell substrates 210 in the fabrication of the process module 20, a used jig and/or a working tolerance of the cell substrates themselves.

The reason is because, on the condition that the “module templates” between the plurality of process modules 20 are identically reproduced through the fabrication of the process modules 20 according to the present invention, a basic problem to solve according to the present invention, i.e. improving the efficiency of the substrate processing process may be accomplished easily by standardizing or calibrating the “process templates” according to the “module templates” measured actually, even if the “module templates” is different from the “process template”.

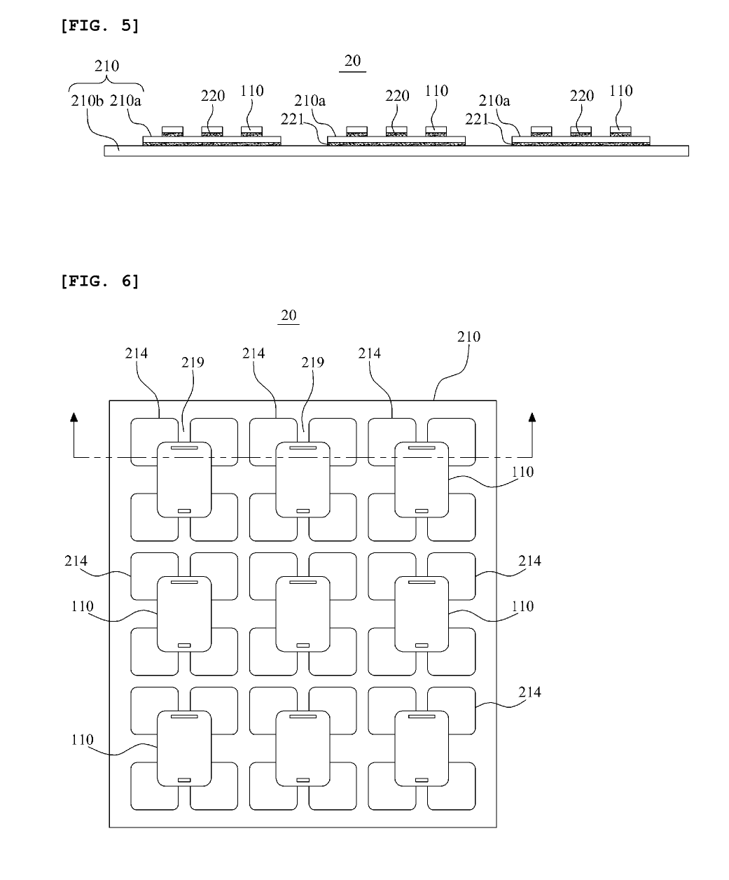

FIG. 5 is a cross-sectional view illustrating a process module according to another embodiment of the present invention. The embodiment of FIG. 5 shows a shape and a structure proposed in terms of increasing the processing capacity of the substrate processing process. In the embodiment, constitutions regarding components of adhesives 220 and 221 and an alignment mark (not shown) may be adopted in the same manner as that of the embodiment of FIGS. 3 and 4, and in this case, the alignment mark may be provided to the uppermost carrier member, that is, a second carrier member 210b.

In the embodiment of FIG. 5, the carrier member 210 has a double layer structure in which a plurality of first carrier members 210a of a specific concept are fixed to a second carrier member 210b of a genus concept by using the adhesive 221. A plurality of cell substrates 110 are fixed on each of the plurality of carrier members 210a by using the adhesive 220.

Meanwhile, in terms of enlarging the substrate processing capacity, the second carrier member 210b may be provided in plurality to be a carrier member of another specific concept, and the plurality of second carrier members 210b may be attached to a third carrier member of another genus concept.

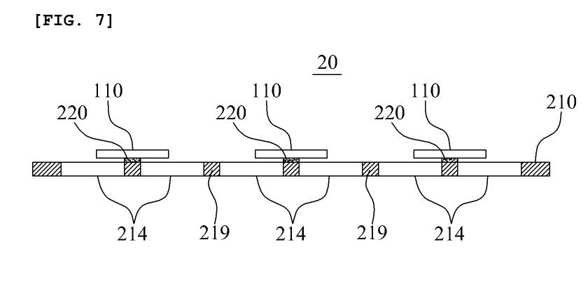

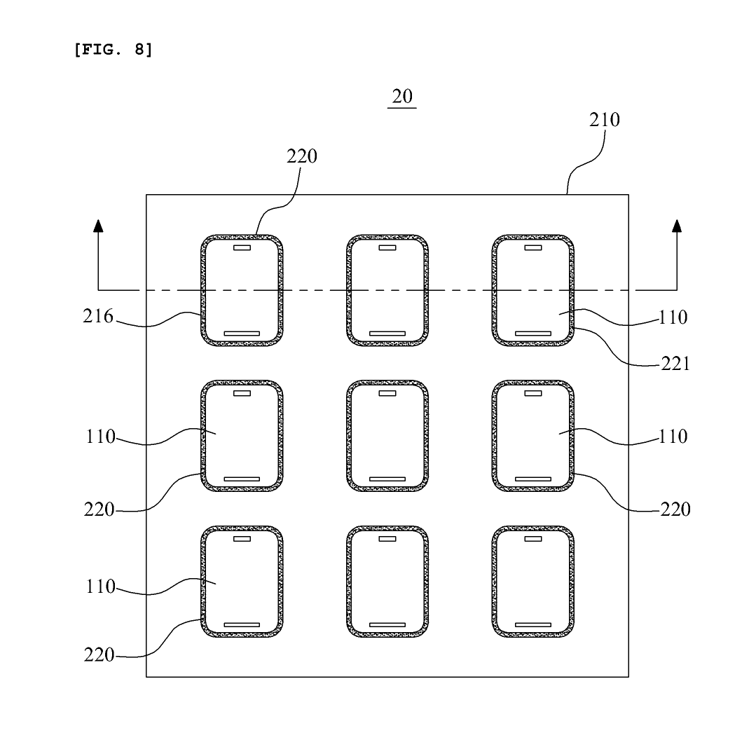

FIGS. 6 and 7 are a top plan view and a cross-sectional view illustrating a process module according to another embodiment of the present invention. The embodiment of FIGS. 6 and 7 shows a shape and a structure proposed in terms of efficiency of the substrate processing process. Constitutions regarding components of adhesives 220 and 221 and an alignment mark (not shown) may be adopted in the same manner as that of the embodiment of FIGS. 3 and 4.

A process module 20 according to this embodiment has a structure in which an exposed surface of each of cell substrates 110 is increased and a contact area between the cell substrates 110 and a carrier member 210 is reduced, and the structure is particularly useful in a substrate processing process, such as a high temperature drying process. In this case, the carrier member 210 has a plurality of holes 214 unlike the embodiment of FIGS. 3 and 4, and each of the cell substrates 210 is adhered to a bridge 219 provided between the plurality of holes 214.

Since in this process module 20, the exposed surfaces of the cell substrates 210 increase, latent heat of an interior of the cell substrates 110 applied during the high temperature substrate processing process may be easily released to upper surfaces and lower surfaces of the cell substrates 110 exposed at the holes 214. By reducing the contact area between the cell substrates 110 and the carrier member 210, even though the carrier member 210 formed of a different material from the cell substrate 210 is used, it may be effectively prevented that the cell substrates 110 are inadvertently separated from the carrier member 210 or damaged due to a difference in thermal expansion coefficient.

Also, since the contact area between the cell substrates 110 and the carrier member 210 is reduced, the amount of the used adhesive 220 and costs may be reduced, and the cell substrates 110 may be easily separated from the process module 20.

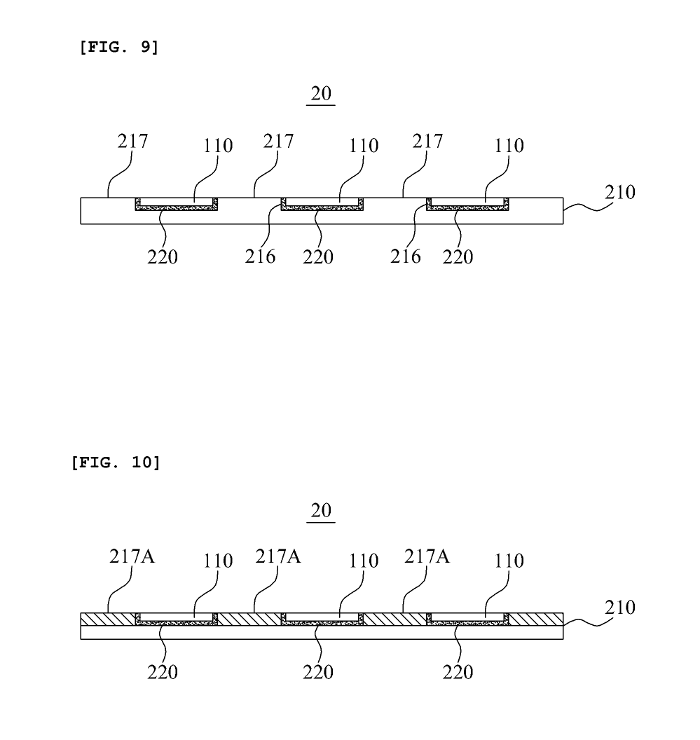

FIGS. 8 and 9 are a top plan view and a cross-sectional view of a process module according to a still other embodiment of the present invention. The embodiment of FIGS. 8 and 9 shows a shape and a structure proposed in terms of substrate processing quality in a subsequent process, easiness in handling of the module itself, and efficiency of the entire process. Constitutions regarding components of an adhesive 220 and an alignment mark (not shown) may be adopted in the same manner as that of the embodiment of FIGS. 3 and 4.

In the process module 20 according to the embodiment of FIGS. 8 and 9, the cell substrates 110 are received in recesses 216 to be fixed by an adhesive 220. A barrier 217 between the recesses 216 is protruded in an upward direction of the carrier member 210. In this case, the upper surface of the cell substrate 110 received in and fixed to the recess 216 is almost coplanar to the upper surface of the barrier 217 by properly adjusting the depth of the recess 216 or the height of the barrier 217, thereby surface contact between the process module 20 and a printing plate or a photomask used in the substrate processing process, such as printing or forming a thin film, may be improved.

Furthermore, in case the plurality of process modules 20 are stacked and carried in order to perform plural substrate processing processes separated temporally and spatially, the danger of physical damage of the cell substrates 110 may be effectively reduced by reducing an exposed region and, at the same time, inadvertent deformation of the “module template” of the process module 20 may be effectively prevented by suppressing movement of the cell substrates 110 by the barrier 217.

In the embodiment of FIGS. 8 and 9, the adhesive 220 may be formed between the cell substrates 110 and any one or all of a bottom surface and sides of the recess 216. In a case the adhesive 220 is limitedly used between the sides of the cell substrate 110 and inner sides of the recess 216, the use amount of the adhesive 220 may be reduced. In this case, since the adhesive area is relatively reduced, it is necessary to control the use amount of the adhesive 220 and the adhesive area within a range so that the “module template” is not changed even in the state a normal pressure is repeatedly applied to the cell substrate 110.

Furthermore, in the embodiment of FIGS. 8 and 9, it is advantageous to temporally align the cell substrates 110 along with a boundary of the recess 216 in the course of aligning and fixing the cell substrates 110 to the carrier member 210 according to the “process template”.

FIG. 10 is a process module 20 according to another embodiment and shows a shape and a structure of a process module 20 that may be proposed for a similar object to the process module 20 of FIGS. 8 and 9. Likewise, constitutions regarding components of an adhesive 220, 221 and an alignment mark (not shown) may be adopted in the same manner as that of the embodiment of FIGS. 3 and 4.

The embodiment of FIG. 10 is characterized in that a filler 217A is filled between cell substrates 110 on the upper surface of a carrier member 210 having a plane geometry. The filler 217A may be formed by applying or printing a curable material or by attaching a double-sided adhesive, and is preferably selected from materials with durability to the substrate processing process. The filler 217A may be formed before or after the cell substrates 110 are attached on the carrier member 210.

The filler 217A is an element functionally corresponding to the barrier 217 of FIGS. 8 and 9. The upper surface of the cell substrate 110 is almost coplanar to the upper surface of the filler 217A by adjusting the height of the filler 217A, thereby surface contact between the process module 20 and a printing plate or a photomask used in the substrate processing process, such as printing or forming a thin film, may be improved.

Also, as in FIGS. 8 and 9, in case the plurality of process modules 20 are stacked and carried in order to perform plural substrate processing process separated temporally and spatially, the danger of physical damage of the cell substrates 110 may be effectively reduced by reducing an exposed region and, at the same time, inadvertent deformation of the “module template” of the process module 20 may be effectively prevented by suppressing movement of the cell substrates 110 by the barrier 217, and it is advantageous to temporarily align the cell substrate 110 along with a boundary of the filler 217A in the course of aligning and fixing the cell substrate 110 to the carrier member 210 according to the “process template”.

Meanwhile, compared with FIGS. 8 and 9, the process module according to the embodiment of FIG. 10 may be provided with excellent flatness and excellent dimensional accuracy, because the carrier member 210 and the filler 217A may be separately formed and the carrier member 210 may be selected from materials with excellent flatness, and because the filler 217A may be selected from materials with excellent workability.

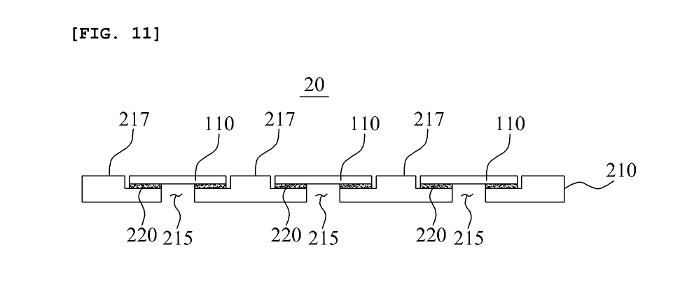

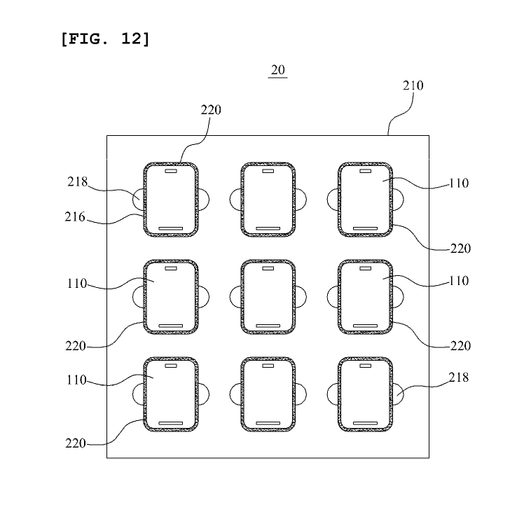

FIG. 11 is a cross-sectional view of a process module according to other modified embodiment of FIGS. 8 and 9. Constitutions regarding components of adhesives 220 and 221 and an alignment mark (not shown) may be adopted in the same manner as those in the embodiment of FIGS. 3 and 4.

In the process module 20 of FIG. 11, a hole 215 is disposed at a bottom surface of a carrier member 210. A size of the hole 215 is formed smaller than a size of the bottom surface of the recess and the cell substrate 110 is fixed to the carrier member 210 by the adhesive 220 along with an end portion of the bottom surface of the recess 216. The process module 20 may implement an effect by the recess 216 as like in the process module of FIGS. 8 and 9, as well as an effect by the hole 215 as like in the process module of FIGS. 6 and 7. Also, in case the process module 20 is separated by using a de-bonding liquid, the de-bonding liquid may be easily permeated through the hole 215 of the recess 216.

FIG. 12 is a cross-sectional view illustrating a process module according to still other modified embodiment of FIGS. 8 and 9. Constitutions regarding components of adhesives 220 and 221 and an alignment mark (not shown) may be adopted in the same manner as that of the embodiment of FIGS. 3 and 4.

In the process module 20 of FIG. 12, extraction grooves 218 are formed in inner sides of recess 216 of a carrier member 210. The process module 20 of FIG. 12 is provided with an effect that facilitates accessibility to the cell substrate 110 in the course of handling the process modules 20 through the extraction grooves 218, together with the effect by recess 216 as like in the process module 20 of FIGS. 8 and 9.

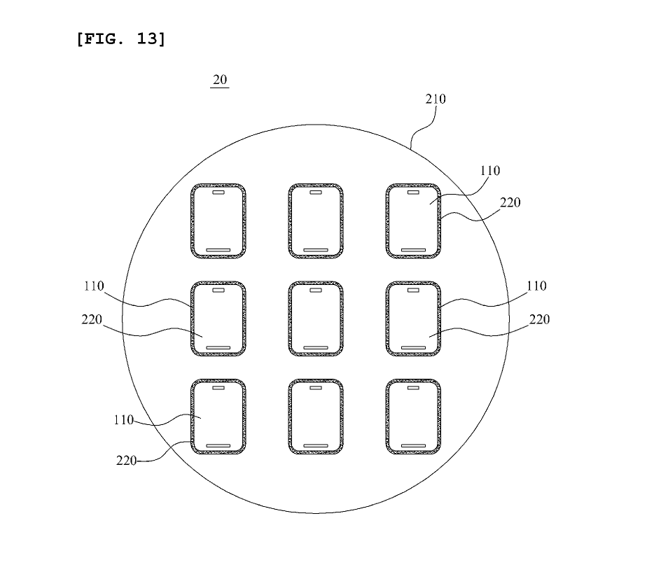

Meanwhile, a plane geometry of the carrier member 210 constituting the process module 20 is not particularly limited, but in case a substrate processing process, such as spin coating of a photoresist (PR) is scheduled, the plane geometry of the carrier member 210 may be advantageously a circle as shown in FIG. 13. Other plane geometries of the carrier member 210, for example, a quadrangle, a polygon, a circle, an oval, or combinations thereof, may be optimally adopted according to the substrate processing process.

### (Fabrication of Process Module)

Summary of Fabrication Process

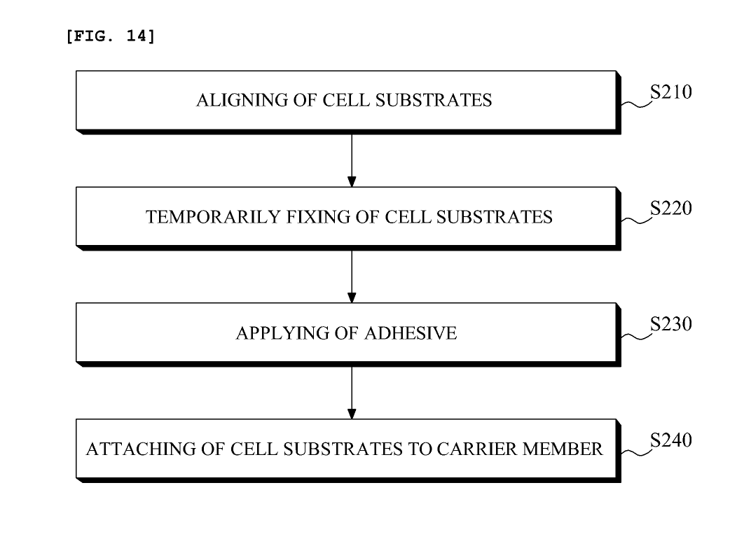

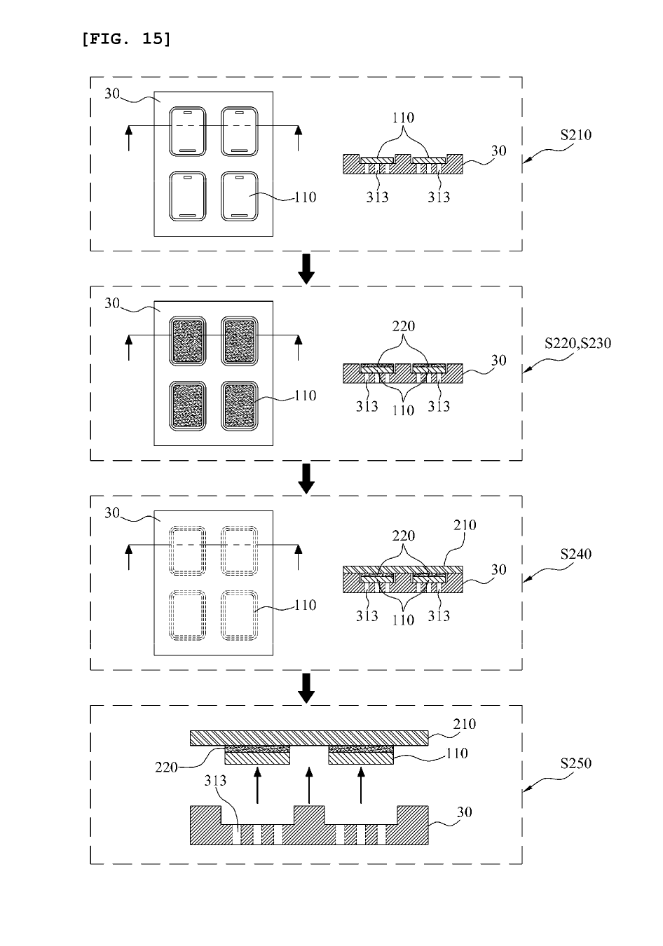

FIG. 14 is a flow chart showing a process of fabricating a process module 20 according to the present invention. A method of fabricating a process module 20 according to the present invention includes aligning (S210) a plurality of cell substrates 110, applying (S230) an adhesive 220 to at least one of surfaces facing each other between cell substrates 110 and a carrier member 210, and attaching (S240) the plurality of cell substrates 110 to the carrier member 210 by using the adhesive 220. Also, the fabricating method may further include temporarily fixing (S220) the plurality of cell substrates 110 as aligned.

FIG. 15 is a schematic view showing a process of fabricating a process module 20 according to an embodiment of the present invention. As shown in the embodiment of FIG. 15, the fabrication of the process module 20 according to the present invention may be performed by using an alignment jig 30, and may be completed by aligning (S210) of cell substrates 110, temporarily fixing (S220) of the cell substrates 110, applying (S230) of the adhesive 220, and separating (S250) the process module 210 with a structure on which the cell substrates 110 and the carrier member 210 are attached from the alignment jig 30.

However, in the fabrication of the process module 20 according to the present invention, the use of the jig 30 shown in FIG. 15 is not essential, but it is advantageous in that the use of the alignment jig 30 facilitates the fabrication of the process module 20, above all thing, allows the “module template” to be reproduced between the plurality of process modules as described later, and further allows the “module template” to be identically reproduced to the “process template.

Meanwhile, in the fabrication of the process module 20 shown in FIG. 10, forming (not shown) of a filler layer 217A may be further performed before or after the cell substrates 110 are attached to the carrier member 210.

Structure of Alignment Jig

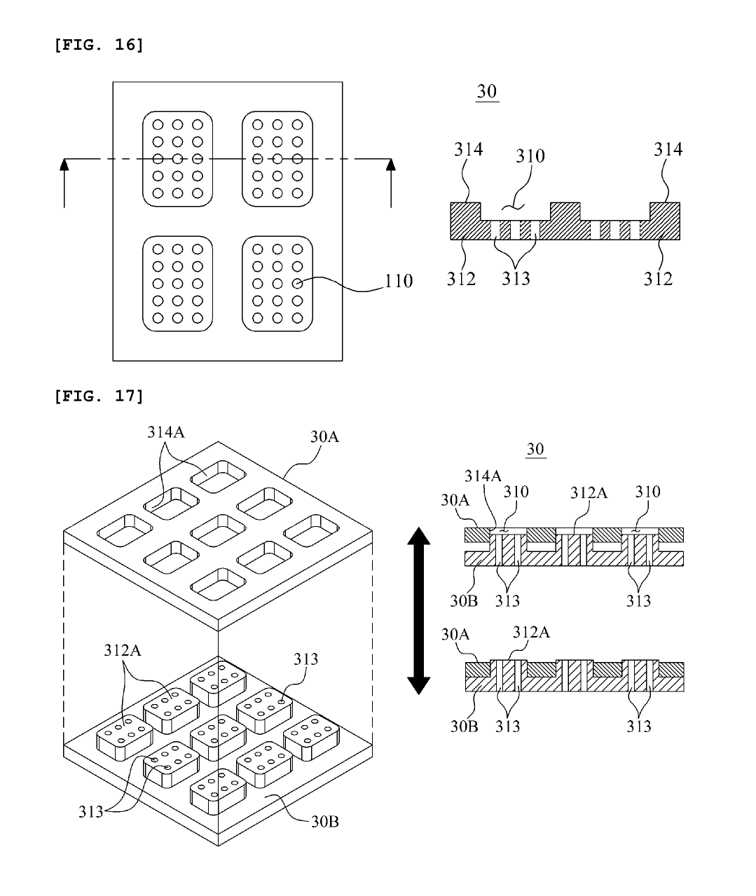

The alignment jig 30 used in fabricating a process module may have an integral structure according to the geometry of the process module 20, for example, as shown in FIGS. 15 and 16. The alignment jig 30 according to an embodiment of FIGS. 15 and 16 is provided with a plurality of seats 310 for receiving a plurality of cell substrates 110, and both a base 312 and walls 314 are integrated to form the plurality of seats 310. The integral alignment jig 30 is suitable for fabrication of the process module 20 having structure in which the cell substrates 110 are protruded in an upper direction of the carrier member 210 as shown in FIGS. 3, 4, 6, and 7. In this case, the height of the wall 314 is properly adjusted in consideration of the thicknesses' of the cell substrate 110 and the adhesive layer 220. Also, in the process module 20 shown in FIG. 10, the integral alignment jig 30 may be applied to a case in which the filler 217A is formed after the cell substrates 110 are attached on the carrier member 210 having a flat plate geometry.

Meanwhile, as shown in FIG. 17, the alignment jig may be provided in a structure in which the jig 30 is separated into an upper jig 30A and a lower jig 30B and coupled to each other. An inner surface 314A of the upper jig 30A and an upper surface 312A of the lower jig 30B form the seats 310. In this case, the lower jig 30B ascends or descends by an up-down means (not shown) along the inner surface of the upper jig 30A. The separable alignment jig 30 is suitable for fabricating the process module 20 having a structure in which upper surfaces of the cell substrates 110 are matched with the upper surface of the carrier member 210 as shown in FIGS. 8, 9, 11, and 12. Also, in the process module 20 shown in FIG. 10, the separable alignment jig 30 may be applied to a case in which the filler 217A is formed before the cell substrates 110 are attached to the carrier member 210 having the flat plate geometry.

Commonly to the alignment jigs 30 of FIGS. 16 and 17, each of the seats 310 is formed in a size not less than the maximum allowable tolerance. Also, a temporary fixing means, for example, a vacuum adsorption means (not shown) for fixing the aligned cell substrates 110 to bottom surfaces of the seats 310 may be provided below the base of FIG. 15 and the lower jig 30B. Vents 313 for vacuum adsorption may be provided in the base of FIG. 15 and the lower jig 30B of FIG. 16. By using the vacuum adsorption means, temporarily fixing (S220 of FIG. 15) the plurality of aligned cell substrates 110 is performed.

Aligning of Cell Substrates

Referring to FIGS. 14 and 15, the aligning (S210) of the plurality of cell substrates 110 is intended to align the cell substrates 110 according to a “process template” in a substrate processing process, and the “process template” may be set in advance. However, as described later, a “module template” may be influenced by aligning standard or method, thereby may not be matched to the intended “process template”. In such a case, it may be required to calibrate the “process template” in the substrate processing process according the actual “module template”.

The alignment of the plurality of cell substrates 110 using the alignment jig 30 according embodiments of the present invention may be performed with reference to centers or corners of the cell substrates 110. Hereinafter, for convenience of explanation regarding the alignment, description will be made assuming that the geometry of the alignment jig 30 has an integral structure, and the geometry of the carrier member 210 has a flat plate geometry.

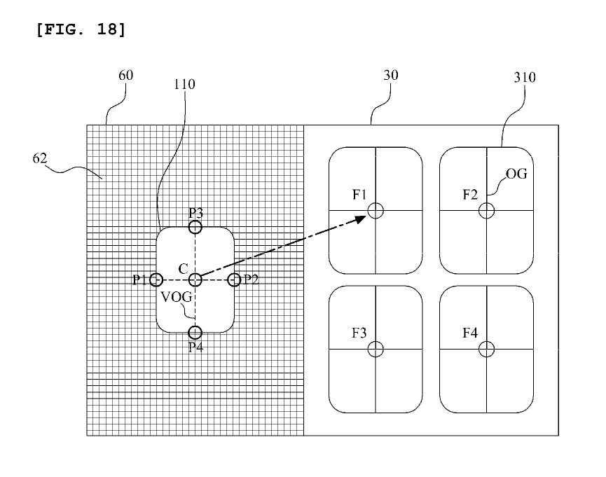

FIG. 18 is a schematic view illustrating a center alignment of cell substrates according to an embodiment of the present invention. In FIG. 18, vents provided to a center alignment jig are omitted in order to clarify a flat plate geometry of the jig 30.

Seats 310 are provided to the center alignment jig 30, and an orthogonal grid (OG) for center alignment is marked on the upper surface of a base 312 within the seats 310. The orthogonal grid (OG) has center points (F1, F2, F3, and F4). The orthogonal grid (OG) may be marked by printing or an intaglio patterning in order not to be interfered with the cell substrates 110.

Regardless of a physical geometry of the seats 310 of the alignment jig 30, the orthogonal grid (OG) may be directly marked on the jig with reference to locations and alignment information of the cell substrates 110 in the “process template”. In this case, since the locations and alignment information of the cell substrates 110 in the “process template” functioning as the standard for center alignment are determined by the orthogonal grid (OG) and the center points (F1, F2, F3, and F4), the seats 310 of the center alignment jig 30 are not necessarily an essential element for center alignment, and the seats 310 of the center alignment jig 30 may function to confirm or guide approximate locations of the cell substrates 110 in the course of alignment or to restrict an entry of a carrier member 210 in the attaching process. Therefore, the sizes and locations of the seats 310 of the center alignment jig 30 may be properly determined in consideration of a physical working tolerance of the seats 310 themselves and a working tolerance of the cell substrates 110 such that the cell substrates 110 do not deviate from the seats 310 after the alignment is completed.

Next, with respect to the cell substrates 110 of which entire outer appearances are measured and shown in FIG. 18, the outermost points (P1, P2, P3, P4) are set, and information of a virtual orthogonal grid (VOG) and a center point(C) thereof defined by virtual connecting lines connecting the outermost points facing each other is obtained.

On the base of the obtained information on the outermost points (P1, P2, P3, and P4), the virtual orthogonal grid (VOG) and the center point (C) of the cell substrates 110 obtained as above, the cell substrates 110 are moved, for example in a pick and place method, to the locations of the orthogonal grids (OG) and the center point (F1, F2, F3, and F4) in the center alignment jig 30 to perform the center alignment process. In detail, the alignment process may be performed by using a three dimensional measuring device having a stage 60 in which a location coordinate 62 is memorized, and the orthogonal grid (VOG) and the center point (C) on the cell substrates 110 are measured to be matched to the specific location coordinate 62 of the stage 60, and the cell substrate 110 is moved in the pick and place method to the location of the orthogonal grid (OG) and the center points (F1, F2, F3, and F4) in the jig 30 on the base of the matched location coordinate values.

In this case, when the center alignment process is performed by using the same alignment jig, a “module template between a plurality of process modules may be identically reproduced. Also, the locations and an alignment state of the cell substrates 100 in the “process template” may be identically transcribed to the locations and an alignment state of the cell substrates 110 in the alignment jig 30. Since the locations and the alignment state of the cell substrates 110 in the alignment jig 30 correspond to the “module template” that is the alignment state of the cell substrates 110 in the process module 20, the “process template” and the “module template” are resultantly matched to each other through the above-described alignment method, so a additional work to calibrate the “process template” to the actual “module template” in the substrate processing process is not necessary.

Furthermore, in case the orthogonal grid (OG) and the center points (F1, F2, F3, and F4) may be directly marked on the jig with reference to information on the locations and the alignment state of the cell substrates 110 in the “process template” regardless of a physical geometry of the seats 310 of the alignment jig 30, the identity between the “process template” and the “module template” is not affected by the working tolerance of the jig 30 or the seats 310 thereof. In this case, although a working tolerance of the cell substrates 110 exists, the identity between the “process template” and the “module template” in the center alignment may be achieved by selecting the cell substrates 110 having a predetermined size or more in consideration of the working tolerance.

Meanwhile, in case the orthogonal grid (OG) and the points (F1, F2, F3, and F4) are marked with reference to the physical geometry of the seat 310 of the alignment jig 30, although a machining process of the seats 310 of the alignment jig 30 is performed with reference to information on the locations and the alignment of the cell substrates 110 in the “process template” set in advance, the identity between the “process template” and the “module template” is difficult to be maintained due to the working tolerance of the seats 310. However, in this case, when the above-described center alignment process is performed by using the identical jig 30, the “module template” among plural process modules may be identically reproduced.

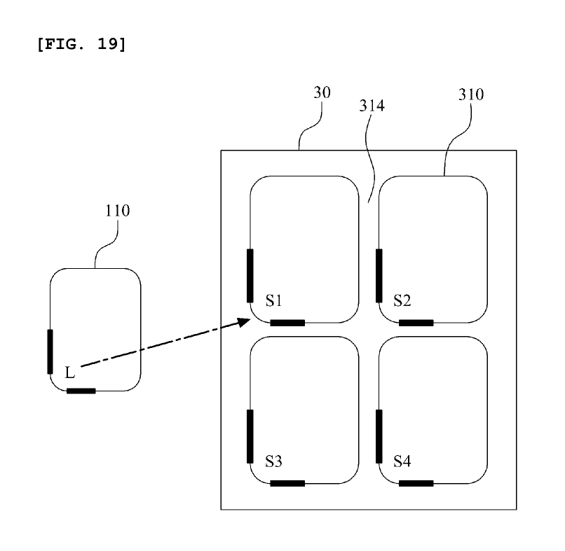

FIG. 19 is a schematic view illustrating an corner alignment of cell substrates according to an embodiment of the present invention. In the embodiment of FIG. 19, a plurality of seats 310 are provided to an alignment jig 30, and each of the seats 310 is processed in a size not less than the maximum allowable tolerance of cell substrates 110. In this case, the alignment is not conducted with reference to a virtual orthogonal grid (VOG) and center points thereof on the cell substrates 110, but is conducted by a method in which outer sides (L) of the cell substrate 110 are aligned to inner walls 314 of the seats 310 of the alignment jig 30, i.e., to the inner sides (S1, S2, S3, and S4) of the wall 314. In detail, the cell substrates 110 may be aligned by mounting the cell substrates 110 are on the seats 310 of the alignment jig 30, then simply tilting the mounted cell substrates 110 or applying an external force (not shown) to the cell substrates 110 to closely move the cell substrates 110 in the direction of the inner sides (S1, S2, S3, and S4) of the wall 314.

In case the identical alignment jig 30 is used in the corner alignment method, since the “module template” may be recognized with reference to the inner sides (S1, S2, S3, and S4) of the seat 310 of the alignment jig 30, the “module template” among a plurality of process modules 20 may be identically reproduced.

Meanwhile, in case of the corner alignment method, since physical geometries of the cell substrates 110 and the alignment jig 30 are selected as a reference for alignment, the “module template” is practically difficult to be identically reproduced to the scheduled “process template” in consideration of a working tolerance between the cell substrates 110 and the alignment jig 30, and thus a working step to calibrate the “process template” in the substrate processing process to the actual “module template” should be accompanied.

Also, since the corner alignment method does not include obtaining information on virtual outermost points (P1, P2, P3, and P4), a virtual orthogonal grid (VOG), and a center point unlike that in FIG. 18, the alignment process may be rapidly performed. However, when considering the working tolerance between the cell substrates 110 in the corner alignment method, a substrate processing region in each of the plurality of cell substrates 110 may be biased to the alignment references, i.e., corners or sides of the cell substrates 110, and in this respect, the above-described center alignment method is more advantageous.

Applying of Adhesive

Referring to FIGS. 14 and 15, when the alignment process of the cell substrates 110 is completed (S210), an operation (S230) in which the cell substrates 110 are temporarily fixed by an arbitrary fixing means (not shown), such as an vacuum suction means provided below the alignment jig 30 (S220) and then applying of an adhesive 220 is performed.

The adhesive 220 is uniformly applied to upper surfaces of the cell substrates 110 by using a metering dispenser (not shown) within a range in which the applied adhesive 220 does not flow down from the cell substrates 110, and the temporary fixing state of the cell substrates 110 by vacuum adsorption is maintained such that an alignment state of the cell substrates 110, i.e. a “module template” is not changed during adhering of the cell substrates 110 to carrier member. Also, in case of a thermosetting or photo-curable adhesive, an applying process is preferably performed in a state that heat or an external light is blocked in order to prevent the adhesive to be cured too early.

The adhesive 220 may be formed only on a portion of the cell substrate 110 unlike shown in the drawing if the adhesive force of the adhesive 220 is degenerated in the substrate processing process and thus an original “module template” is not changed.

Meanwhile, the applying of the adhesive 220 may be performed on any side of either a carrier member 220 or the cell substrates 110. However, since the cell substrate 110 needs be temporally fixed (S220) such that the “module template” is not changed until the attaching process is completed and the carrier member 210 approaches from the above of the cell substrate 100 and is then attached in an actual adhesion process, the adhesive 220, if in a liquid state, may be preferably applied on the cell substrates 110 as exemplified in the embodiment.

Furthermore, in order to constantly maintain the thickness of the adhesive layer in a process module, beads (not shown) having a uniform size may be added to the adhesive 220 as spacers.

Adhering of Carrier Member and Extracting of Process Module

Referring to FIGS. 14 and 15, in the state that the adhesive 220 is uniformly applied to the upper surfaces of the cell substrates 110, the carrier member 210 approaches from the above of the cell substrates 100 and then closely contacts the upper surfaces of the cell substrates 110, and then the adhesive 220 is cured by applying heat or UV to the adhesive 220 (S240).

In this case, the carrier member 210 is aligned according to a predetermined reference, and an alignment of the carrier member 210 may be performed by a similar method to the above-described center alignment method of the cell substrates 110, or by a similar method to the above-described corner alignment method of the cell substrates 110 using a separate guide block (not shown). In case the carrier member 210 is aligned by using an alignment mark, it may be understood that the physical alignment mark is used in the carrier member 210 unlike the center alignment of the cell substrates 110.

Finally, when the adhesive 220 is completely cured, the vacuum suction applied below the alignment jig 30 is decomposed, and then the process module 20 having a structure in which the cell substrates 210 and the carrier member 210 are attached to each other is fetched from the alignment jig 30 (S250), thereby completing the fabrication of the process module 20.

### (Substrate Processing Process)

A substrate processing process is performed in a unit of the process module fabricated as above (S30 of FIG. 1). Meanwhile, as described above, the substrate processing process may be changed according to the use of a target cell substrate 110 to be processed, and the “processing” includes a process for providing a decorative element, such as a surface pattern, or a process for proving a functional element, such as a thin film. Also, the “processing” process may include one or more processing processes, which are temporally or spatially continuous or separated.

Since the process module 20 has a structure in which the cell substrates 110 are rigidly attached to the carrier member 210 by an adhesive, the “module template” of the process module is identically maintained throughout the plurality of substrate processing processes. Also, the “process template” in the plurality of substrate processing processes is presumed identical or identically calibrated to the “module template” which is an aligned state of the cell substrates 110 in the process module 20. Therefore, in each of the substrate processing processes, in the state that the alignment process is simplified in such a way that the “module template” of the process module 20 is simply matched to the “process template” without a separate or additional aligning process for each of the plurality of cell substrates 110 mounted on the process module, the massive processing of the cell substrates may be performed. In this case, the aligning of the “module template” of the process module 20 to the “process template” in each of the substrate processing processes may be performed, for example, with reference to an alignment mark provided to the carrier member 210.

Hereinafter, for convenience of explanation, the embodiment of a substrate processing process will be described by exemplifying a cover glass of a display device with a touch screen function or a glass for touch screen to which the substrate processing process according to the present invention may be particularly advantageously applied.

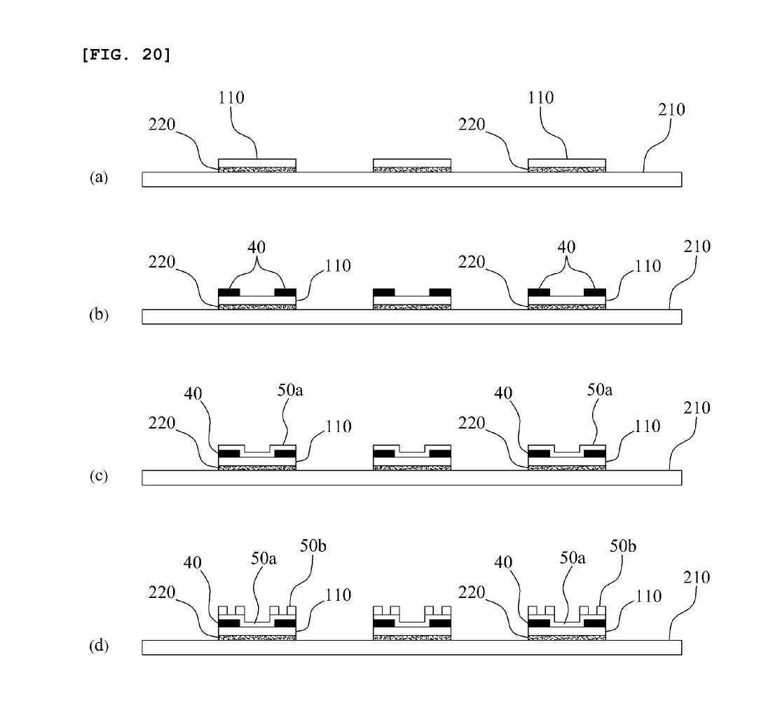

FIG. 20 is a schematic view illustrating a substrate processing process for a glass for touch screen according to an embodiment of the present invention, in which a substrate processing process for a decorative element, such as a printed layer 40 and a substrate processing process for a functional element, such as thin film layers 50a and 50b for the touch screen function are illustrated.

First, as shown in FIG. 20A, a process module 20 having a structure in which cell substrates 110 are attached on a carrier member 210 by an adhesive 220 is prepared as a unit of a substrate processing process.

Next, as shown in FIG. 20B, a printed layer 40 is formed on the cell substrates 110 by using a screen printing plate. The printed layer 40 may be formed by performing the printing process several times to several ten times, and may include a foreground color, a background color, a border, a logo, an icon, a pattern, a back layer, a camera window, an infrared window, a light blocking layer, and the like. The respective printing processes use printing plates different from one another. Also, the forming of the printed layer 40 may be performed by laminating a decorative film.

Next, as shown in FIGS. 20C and 20D, a thin film layer for implementing the touch screen function is formed on the cell substrates 110, and the thin film layer includes a touch sensor layer 50a and an electrode layer 50b.

In FIG. 20C, since a display device on a back surface of the touch sensor layer 50a should be displayed, the touch sensor layer 50a may be formed by depositing transparent Indium Tin Oxide having high conductivity. In case the touch sensor layer 50a is formed of a metal nanowire, such as silver, copper, or the like, the touch sensor layer 50a may be formed by printing with an ink containing nanowire therein.

In FIG. 20D, the electrode layer 50b electrically connected to the touch screen layer 50a so as to deliver a touch signal to an exterior is formed. Since the electrode layer 50b is formed in an outward direction on the touch sensor layer 50a, and is not visible from an outside on a display device region, the electrode layer 50b is not need to be transparent and may be formed by printing a high conductivity metal thin film layer or a metal paste layer, such as silver.

However, in FIGS. 20(c) and 20(d), the kind and the structure of the thin film layer are not construed as being limited, either. For example, in an electrostatic capacitive touch sensor, an insulating layer as well as a two or more layered touch sensor layer constituting a Tx electrode and an Rx electrode may be formed (G2 type). A film layer provided with a touch sensor layer may be laminated to a cell substrate in which a portion of the touch sensor layer is implemented by a thin film (G1F type). Also, a single layered touch sensor layer constituting a Tx electrode and an Rx electrode may be formed (G1M type).

While the embodiment of FIG. 20 shows and describes that all of the printed layer as a decorative element and the thin film layer as a functional element are formed, it is also possible only any one of these layers be formed.

### (Separating of Process Module and Cleaning of Cell Substrate)

After the substrate processing process is completed (S30 of FIG. 1), the operation (S40 of FIG. 1) of separating the process module and the operation (S50 of FIG. 1) of cleaning the cell substrate 110 separated from the process module are performed, thereby completing of fabrication of the cell substrate to a final product.

However, the operation (S40 of FIG. 1) of separating the process module is selectively included in the entire substrate processing process, and for example, in case the substrate processing process is separated temporally and spatially, a process module itself in which only a portion of the substrate processing process is completed may be handled as a half-finished product.

The operation (S40 of FIG. 1) of separating the process module is performed by delaminating and peeling the adhesive 220.

A delaminating method is determined according to the kind of the adhesive 220. Particularly, since a moisture absorption peelable adhesive has easiness of separation and a low possibility of damage to the substrate, it may be advantageously adopted in the fabrication and decomposition of the process module. For example, in case of the moisture absorption peelable adhesive decomposed by dipping the adhesive in warm water having a temperature of approximate 50° C. to 90° C., since the decomposition temperature of the adhesive is higher than a partial cleaning temperature of the process module during the substrate processing process, there is no risk of damage to the “module template” of the process module, which might be caused by the separation of the process module or reduction of the adhesive strength during the substrate processing process. Also, since water having a chemical reactivity lower than organic compounds is used to decompose the process module, the printed layer, etc. formed through the substrate processing process is not damaged and, at the same time, the cell substrate itself may be cleaned through the decomposing process. Furthermore, a UV peelable adhesive may be used when the substrate processing process does not accompany an UV process, and, in this case, the overall process time may be shortened by omitting a additional drying process.

Finally, the carrier member 210 and the cell substrate 110 separated from each other are dried after the additional cleaning, thus completing the separating and cleaning of the process module. The carrier member 210 from which the remaining adhesive is removed may be recycled.

While this invention has been particularly shown and described with reference to exemplary embodiments thereof, it will be understood by those skilled in the art that various changes in form and details may be made therein without departing from the spirit and scope of the invention as defined by the appended claims.

For example, the substrate processing method according to the present invention may be applied to attaching devices processed in a final dimension to each other.

For example, in mobile display devices, a cover glass, a decorative film, a touch panel and a display device are attached to each other in a state machined in final dimensions, i.e., in a state that does not additively need a change in dimension, so as to produce a final product.

In this case, it may be understood that any one of the elements machined in the final dimensions corresponds to the cell substrates in the process module according to the present invention and, that the process of attaching such elements corresponds to the substrate processing process according to the present invention.

The process of attaching the elements machined in the final dimensions to each other may include a process of laminating a decorative film or a touch panel on a cover glass, and a process of attaching a display device on a touch panel in a state that a cover glass is attached or not attached.

Therefore, it may be understood that these all changes and modifications are within the scope of the invention disclosed in claims or correspond to equivalents thereof.

1. A substrate processing method in which at least one substrate processing process is performed with respect to a plurality of cell substrates separated from a bare sheet, the method comprising:
fabricating a process module having a structure in which the plurality of cell substrates are attached to a carrier member in an aligned state; and
performing the substrate processing process by using the fabricated process module.

2. The method of claim 1, wherein the cell substrate is surface-strengthened before the process module is fabricated.

3. The method of claim 1, wherein the attaching of the cell substrates to the carrier member uses a debondable adhesive.

4. The method of claim 3, wherein the debondable adhesive is a warm water-peelable adhesive or a UV peelable adhesive.

5. The method of claim 1, wherein the at least one substrate processing process provides at least one of a decorative element and a functional element.

6. The method of claim 1, wherein the substrate processing process comprises at least two substrate processing processes which are separated temporally or spatially.

7. The method of claim 5, wherein the functional element comprises a sensor layer or an electrode layer for a touch screen function.

8. The method of claim 1, wherein the substrate processing process is a process of attaching devices which are machined to a final dimension.

9. The method of claim 1, wherein the carrier member has the same thermal expansion coefficient as the cell substrates.

10. The method of claim 1, wherein the carrier member has a structure in which a plurality of first carrier members are attached to a second carrier member, and the plurality of cell substrates are attached to each of the plurality of first carrier members.

11. The method of claim 1, further comprising separating the cell substrates from the carrier member after the substrate processing process.

12. The method of claim 11, wherein the attaching of the cell substrates to the carrier member uses a debondable adhesive, and the separating of the cell substrates from the carrier member is performed by dipping the process module in water.

13. The method of claim 11, wherein the attaching of the cell substrates to the carrier member uses a debondable adhesive, and the separating of the cell substrates from the carrier member is performed by irradiating UV light.

14. The method of claim 11, further comprising cleaning the cell substrates separated from the carrier member.

15. The method of claim 1, wherein the fabricating of the process module comprises:
aligning the plurality of cell substrates according to a preset alignment standard;
applying an adhesive to at least one of surfaces facing each other between the plurality of cell substrates and the carrier member; and
attaching the plurality of cell substrates to the carrier member by using the adhesive.

16. The method of claim 15, wherein the aligning of the plurality of cell substrates uses an alignment jig on which an orthogonal grid for center alignment is marked, and is performed in a manner that a virtual orthogonal grid on the cell substrates is matched to the orthogonal grid for center alignment.

17. The method of claim 16, wherein a seat for receiving the plurality of cell substrates is provided to the center alignment jig, and the orthogonal grid for center alignment is matched to the center of the seat.

18. The method of claim 15, wherein the aligning of the plurality of cell substrates is performed by using an alignment jig having a seat for receiving the plurality of cell substrates, and the plurality of cell substrates are aligned to the center or the corner of the seat.

19. A process module used in a substrate processing method performing at least one substrate processing process for a plurality of cell substrate separated from a bare sheet, wherein the plurality of cell substrates are attached to a carrier member by an adhesive according to a preset alignment standard.

20. The process module of claim 19, wherein the cell substrate is surface-strengthened.

21. The process module of claim 19, wherein the adhesive is a debondable adhesive.

22. The process module of claim 21, wherein the debondable adhesive is a warm water peelable adhesive or a UV peelable adhesive.

23. The process module of claim 19, wherein the carrier member has the same thermal expansion coefficient as the cell substrate.

24. The process module of claim 19, wherein the carrier member has a structure in which a plurality of first carrier members are attached to a second carrier member, and the plurality of cell substrates are attached to each of the plurality of first carrier members.

25. The process module of claim 19, wherein the carrier member is provided with a plurality of holes, and each of the cell substrates is attached to a bridge between the plurality of holes.

26. The process module of claim 19, wherein the carrier member is provided with a recess for receiving the cell substrates.

27. The process module of claim 19, wherein a filler filling the space between the cell substrates is provided on the upper surface of the carrier member.

28. The process module of claim 26, wherein an extraction groove is formed at the side of the recess of the carrier member.

29. The process module of claim 26, wherein a hole is formed at the bottom of the recess of the carrier member.

30. The process module of claim 19, wherein an alignment mark is provided to the carrier member.

31. The process module of claim 19, wherein the cell substrate comprises a printed layer, a thin film layer, or the combination thereof.

32. The process module of claim 31, wherein the thin film layer comprises a sensor layer or an electrode layer for a touch screen function.

33. A method for fabricating a process module used in a substrate processing method performing at least one substrate processing process for a plurality of cell substrate separated from a bare sheet, the method comprising:
aligning the plurality of cell substrates according to a preset alignment standard;
applying an adhesive to at least one of surfaces facing each other between the plurality of cell substrates and the carrier member; and
attaching the plurality of cell substrates to the carrier member by using the adhesive.

34. The method of claim 33, wherein the aligning of the plurality of cell substrates is performed by using an alignment jig on which an orthogonal grid for center alignment is marked, in a manner that a virtual orthogonal grid for the cell substrates is matched to the orthogonal grid for center alignment.

35. The method of claim 33, wherein a seat for receiving the plurality of cell substrates is provided to the alignment jig, and the center of the orthogonal grid for center alignment is matched to the center of the seat.

36. The method of claim 33, wherein the aligning of the plurality of cell substrates is performed by using an alignment jig having a seat for receiving the plurality of cell substrates, and the plurality of cell substrates are aligned to the center or the corner of the seat.

37. The method of claim 33, further comprising temporarily fixing the plurality of cell substrates by a vacuum suction.

38. A substrate processing method performing at least one substrate processing process for a plurality of cell substrates separated from a bare sheet, the method comprising:
fabricating a process module having a structure in which the plurality of cell substrates are attached to a carrier member in an aligned state; and
performing the substrate processing process for the plurality of cell substrates at the same time by using the process module,
wherein the alignment standard for the plurality of cell substrates in the substrate processing process is calibrated to the alignment state of the cell substrates in the process module.

39. The method of claim 38, wherein the cell substrate is surface-strengthened before the process module is fabricated.

40. The method of claim 38, wherein the attaching of the cell substrates to the carrier member is performed by using a debondable adhesive.

41. The method of claim 38, wherein the debondable adhesive is a warm water peelable adhesive or a UV peelable adhesive.

42. The method of claim 38, wherein the at least one substrate processing process provides at least one of a decorative element and a functional element.

43. The method of claim 38, wherein the substrate processing process comprises a plurality of substrate processing processes, which are separated temporally or spatially.

44. The method of claim 42, wherein the functional element comprises a sensor layer or an electrode layer for a touch screen function.

45. The method of claim 38, wherein the substrate processing process is a process of attaching devices to each other, which are machined to a final dimension.

46. The method of claim 38, wherein the carrier member has the same thermal expansion coefficient as the cell substrate.

47. The method of claim 38, wherein the carrier member has a structure in which a plurality of first carrier members are attached to a second carrier member, and the plurality of cell substrates are attached to each of the plurality of first carrier members.

48. The method of claim 38, further comprising separating the cell substrates from the carrier member after the substrate processing process is performed.

49. The method of claim 48, wherein the attaching of the cell substrates to the carrier member is performed by using a debondable adhesive and the separating of the cell substrate from the carrier member is performed by dipping the process module in water.

50. The method of claim 48, wherein the attaching of the cell substrates to the carrier member uses a debondable adhesive, and the separating of the cell substrate from the carrier member is performed by irradiating UV light.

51. The method of claim 48, further comprising cleaning the cell substrate separated from the carrier member.

52. The method of claim 38, wherein the fabricating of the process module comprises:
aligning the plurality of cell substrates according to a preset alignment standard;
applying an adhesive to at least one of surfaces facing each other between the plurality of cell substrates and the carrier member; and
attaching the plurality of cell substrates to the carrier member by using the adhesive.

53. The method of claim 52, wherein the aligning of the plurality of cell substrates is performed by using an alignment jig on which an orthogonal grid for center alignment is marked, in a manner that a virtual orthogonal grid on the cell substrate is matched to the orthogonal grid for center alignment.

54. The method of claim 53, wherein a seat for receiving the plurality of cell substrates is provided to the alignment jig, and the center of the orthogonal grid for center alignment is matched to the center of the seat.

55. The method of claim 52, wherein the aligning of the plurality of cell substrates is performed by using an alignment jig provided with a seat for receiving the plurality of cell substrates, and the plurality of cell substrates are aligned to the center or the corner of the seat.
